(19) United States
(12) Patent Application Publication
(10) Pub. No.: US 2004/0006772 A1
(43) Pub. Date: Jan. 8, 2004

(54) Centralized video and data integration unit

(76) Inventors: Ahmad Ansari, Austin, TX (US); Pierre Costa, Austin, TX (US); Brad A. Medford, Austin, TX (US)

Correspondence Address: BRINKS HOFER GILSON & LIONE, P.O. BOX 10395, CHICAGO, IL, 60611, US

(21) Appl. No.: 10/286,384

(22) Filed: Oct. 31, 2002

Related U.S. Application Data
(63) Continuation-in-part of application No. 10/191,743, filed on Jul. 8, 2002.
(63) Continuation-in-part of application No. 10/201,537, filed on Jul. 22, 2002.

(51) Int. Cl. H04N 7/18

(52) U.S. Cl. 725/120; 725/82; 725/126; 725/109

(57) ABSTRACT

Each of a plurality of remote control devices is to receive a user-initiated video selection of any of a plurality of channels. Each of a plurality of video processing modules is responsive to a corresponding one of the remote control devices to request a channel based on the user-initiated video selection. A distribution module simultaneously receives all channels requested by the video processing modules and distributes the channels to those of the video processing modules requesting same. Each of a plurality of modulators is to generate a television signal based on the channel requested by an associated video processing module. A network interface is in communication with a modem to provide a data networking signal. Each of a plurality of combiners combines the television signal from a modulator with the data networking signal to form a corresponding combined television and data networking signal.

### RELATED APPLICATIONS

The present application is continuation-in-part of the following applications:

“SYSTEM FOR PROVIDING DBS AND DSL VIDEO SERVICES TO MULTIPLE TELEVISION SETS”, having Attorney Docket Code T00433, application Ser. No. 10/191,743, filed Jul. 8, 2002, pending; and

“CENTRALIZED IN-HOME UNIT TO PROVIDE VIDEO AND DATA TO MULTIPLE LOCATIONS”, having Attorney Docket Code T00436, application Ser. No. 10/201,537, filed Jul. 22, 2002, pending.

The entire contents of the aforementioned applications are hereby incorporated by reference to the disclosure of the present application.

### BACKGROUND OF THE INVENTION

1. Field of the Invention

The present invention relates to video and broadband data services.

2. Description of the Related Art

A key challenge in delivering video services using direct broadcast satellite (DBS) and digital subscriber line (DSL) is the integration of the two networks in a seamless manner. Typically, homes have one distribution network to deliver DBS service and another distribution network to deliver DSL service to its various rooms. The DSL service is delivered to the various rooms by a telephone distribution network within a home. The telephone distribution network typically comprises twisted-pair copper lines which are connected to a telephony company network. The DBS service is delivered to the various rooms by a video distribution network within a home. The video distribution network typically comprises coaxial cables which are connected to a DBS dish.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram of an embodiment of a system to provide video and broadband data services to multiple televisions and computers in a home;

FIG. 2 is a block diagram of an embodiment of a centralized video and data integration unit;

FIG. 3 is a block diagram of an embodiment of a data packet to television signal converter; and

FIG. 4 is a schematic, block diagram showing an embodiment of a receiving end of the system.

### DETAILED DESCRIPTION OF THE PREFERRED EMBODIMENTS

Disclosed herein are single centralized units to deliver video and data services to multiple televisions and computers via a coaxial distribution network in a home. The coaxial distribution network is also used for home data networking using Ethernet over coax technology. In contrast to deploying individual set-top boxes, the disclosed centralized unit lowers the overall cost of providing video and data services to multiple television sets and computers. Further, the single centralized units can be used to provide both video and value-added Internet-based services such as e-mail, instant messaging, web browsing, e-commerce, and other interactive services for television viewers using a combination of DBS video and DSL broadband services.

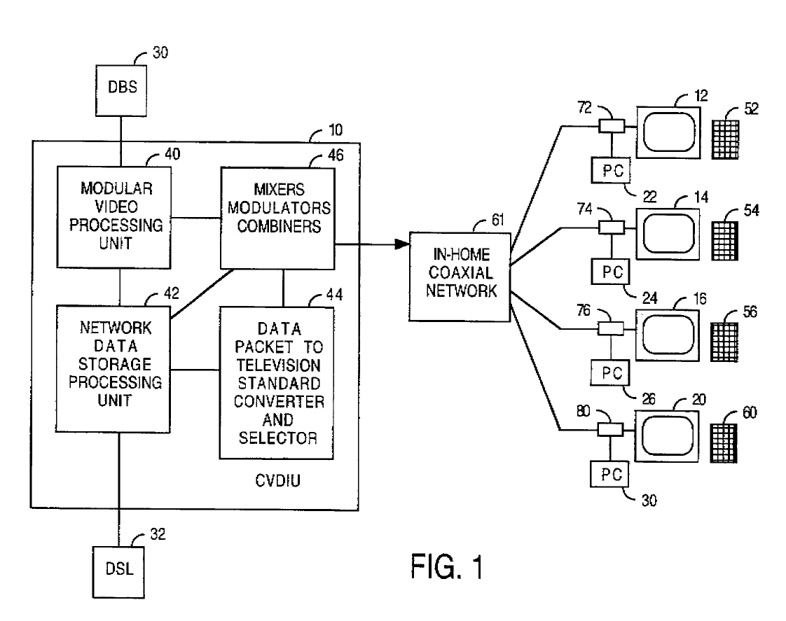

FIG. 1 is a block diagram of an embodiment of a system to provide video and broadband data services to multiple televisions and computers in a home. The system comprises a centralized video and data integration unit (CVDIU) 10. The CVDIU 10 serves to provide multi-channel digital video services to multiple television sets 12, 14, 16 and 20 in the home without the need for multiple set-top boxes within the home. Further, the CVDIU 10 serves to provide broadband data services to multiple personal computers (PCs) 22, 24, 26 and 30 in the home.

Video service signals are provided to the home by a DBS receiver 30. The video service signals may include any combination of broadcast video channels, pay-per-view (PPV) channels, and near video-on-demand (NVOD) channels provided by a DBS service. For the purpose of this patent application, the term “video” should be construed as being inclusive of both video with accompanying audio and video without accompanying audio. Broadband data service signals are provided to the home by a digital subscriber line (DSL) service 32. The broadband data signals may be in accordance with any DSL standard.

The CVDIU 10 has an architecture that can be divided into four main functional blocks: a modular video processing unit (MVPU) 40; a network, data, storage and processing unit (NDSPU) 42; a data packet to television standard converter and selector (DPTSCS) 44; and mixers, modulators and combiners (MMC) 46.

The MVPU 40 is responsive to a plurality of remote control devices 52, 54, 56 and 60 to request video service channels from the DBS receiver 30. The remote control devices 52, 54, 56 and 60 are associated with the televisions 12, 14, 16 and 20, respectively. The MVPU 40 processes video service signals from the DBS receiver 30 for delivery to the televisions 12, 14, 16 and 20. The MVPU 40 decodes compressed video data to generate standard television signals.

The NDSPU 42 processes broadband data signals from the DSL service 32 for delivery to the PCs 22, 24, 26 and 30. The NDSPU 42 is also responsible for handling Ethernet over coax packets. The NDSPU 42 also provides video feeds from the DSL service 32 to the MVPU 40. Examples of these video feeds include, but are not limited to, video-on-demand (VOD) and near video-on-demand (NVOD) from a DSL network. Here, the MVPU 40 decodes compressed data from the NDSPU 42 to generate a standard television signal. The NDSPU 42 has storage such as a disk used to locally store downloaded content such as VOD content or other content for subsequent playback.

The DPTSCS 44 is responsive to the NDSPU 42 to convert packets contained in the broadband data signals to a television signal in accordance with a television standard.

Examples of any herein-disclosed standard television signal include, but are not limited to, analog National Television Systems Committee (NTSC), digital NTSC, digital High-Definition Television (HDTV), digital Standard-Definition Television (SDTV), Phase Alternation each Line (PAL) and Sequential Color with Memory (SECAM).

The MMC 46 is responsive to signals from MVPU 40, the NDSPU 42, and the DPTSCS 44 to form combined signals that can be delivered via an in-home coaxial network 61 to the televisions 12, 14, 16 and 20, and the PCs 22, 24, 26 and 30. Typically, the in-home coaxial network 61 comprises 50-Ohm or 75-Ohm coaxial cables, although other coaxial cables are within the scope of this disclosure.

A passive splitter 72 splits a first television signal and a first Ethernet data signal from the first combined signal. The passive splitter 72 provides the first television signal to the television 12, and provides the first Ethernet data signal to a port, such as an Ethernet port, of the personal computer 22.

A passive splitter 74 splits a second television signal and a second Ethernet data signal from the second combined signal. The passive splitter 74 provides the second television signal to the television 14, and provides the second Ethernet data signal to a port, such as an Ethernet port, of the personal computer 24.

A passive splitter 76 splits a third television signal and a third Ethernet data signal from the third combined signal. The passive splitter 76 provides the third television signal to the television 16, and provides the third Ethernet data signal to a port, such as an Ethernet port, of the personal computer 26.

A passive splitter 80 splits a fourth television signal and a fourth Ethernet data signal from the fourth combined signal. The passive splitter 80 provides the fourth television signal to the television 20, and provides the fourth Ethernet data signal to a port, such as an Ethernet port, of the personal computer 30.

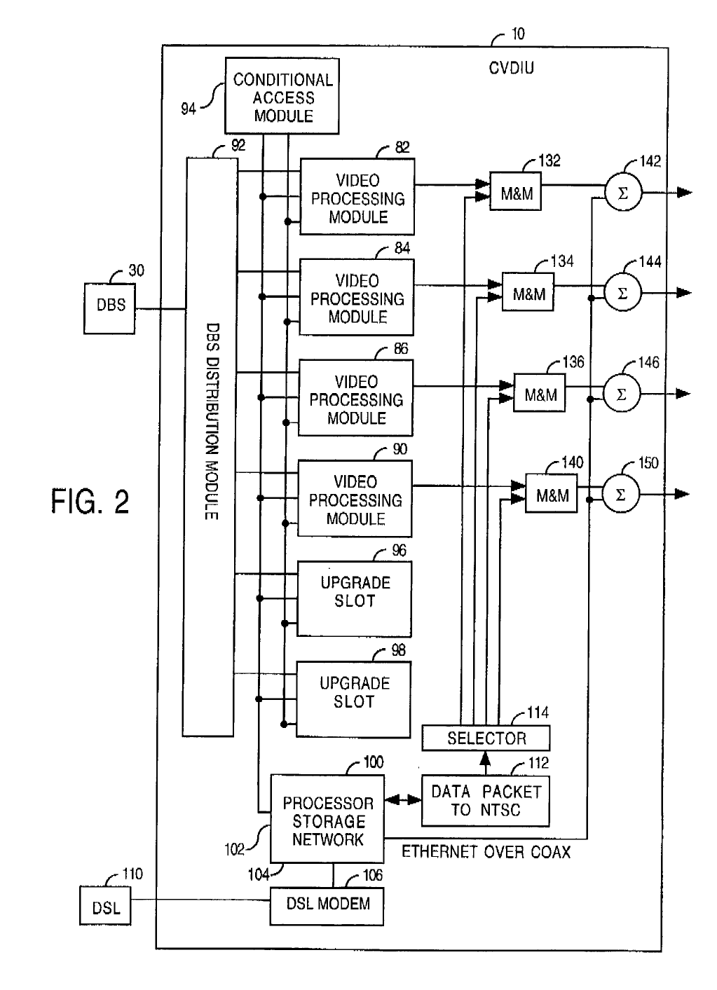

FIG. 2 is a block diagram of an embodiment of the CVDIU 10. The CVDIU 10 comprises a plurality of video processing modules, one per television set in the home. For purposes of illustration and example, four video processing modules 82, 84, 86 and 90 are depicted, although any plurality of video processing modules may be employed. Each of the video processing modules 82, 84, 86 and 90 has a corresponding input coupled to a DBS distribution module 92. The DBS distribution module 92 distributes incoming satellite video signals to the multiple video processing modules 82, 84, 86 and 90.

Each video processing module performs video processing acts such as decoding compressed video data into a television standard signal for its associated television set. For purposes of illustration and example, each video processing module will be considered to decode compressed video data into an NTSC Standard composite signal. A conditional access module 94 enables the video processing modules 82, 84, 86 and 90 to receive and descramble premium channels, if necessary. The conditional access module 94 is capable of managing more than one video processing module. The conditional access module 94 is remotely controlled to enable or disable programming content access to each television.

Preferably, each video processing module is embodied by a removable card that facilitates installation in and removal from the CVDIU 10 based on an end-user's subscription package. In this case, the CVDIU 10 has a plurality of card-receiving slots to receive a plurality of video processing modules. For purposes of illustration and example, the CVDIU 10 may have six card-receiving slots to receive at most six video processing modules. Thus, with four video processing modules in the CVDIU 10, two card-receiving slots 96 and 98 are unoccupied. The CVDIU 10 may be upgraded to accommodate more than four television sets by installing one or two video processing modules in the two card-receiving slots 96 and 98. Alternatively, some of the video processing modules 82, 84, 86 and 90 may be permanently integrated with the CVDIU 10, in other words, may be non-removable from the CVDIU 10.

Each of the remote control devices 52, 54, 56 and 60 from FIG. 1 controls acts performed by a corresponding one of the video processing modules 82, 84, 86 and 90, respectively. Preferably, each remote control device communicates with its associated video processing module by a wireless link. Alternatively, a remote control device may communicate with a video processing module by a wireline connection.

The DBS distribution module 92, the conditional access module 94, and the video processing modules 82, 84, 86 and 90, are elements of the MVDP 40 in FIG. 1. The NDSPU 42 in FIG. 1 comprises a main system processor 100, a storage unit 102, a network interface 104, and a modem 106. The main system processor 100 directs operations of the NDSPU 42.

The modem 106 extracts/demodulates the broadband data from a telephone network 110 which provides a communication link to a DSL service provider. For purposes of illustration and example, the modem 106 comprises a DSL modem. The network interface 104 is in communication with the modem 106 to generate a data networking signal based on DSL signals received by the modem 106. Preferably, the data networking signal is in accordance with an Ethernet standard to communicate (i.e. transmit and receive) data with the personal computers 22, 24, 26 and 30. The modem 106 and network interface 104 further cooperate to modulate data received from the personal computers 22, 24, 26 and 30 for transmission to the DSL service provider via the telephone network 110.

The storage unit 102 stores video downloaded from either the DSL service or the DBS service to provide a personal video recording function. The stored video can be selected using any of the remote control devices 52, 54, 56 and 60 for playback on any of the television sets 12, 14, 16 and 20, respectively.

To facilitate user selection of the record function, the remote control devices 52, 54, 56 and 60 may comprise a dedicated record function key, a soft key temporarily dedicated to the record function, and/or a selection key which facilitates an on-screen selection of the record function.

Each of the video processing modules 82, 84, 86 and 90 is responsive to its corresponding one of the remote control devices 52, 54, 56 and 60 to request that stored video be retrieved from the storage unit 102 for playback on the corresponding one of the television sets 12, 14, 16 and 20. To facilitate user selection of the record function, the remote control devices 52, 54, 56 and 60 may comprise a dedicated playback function key, a soft key temporarily dedicated to the playback function, and/or a selection key which facilitates an on-screen selection of the playback function.

Examples of the storage unit 102 include, but are not limited to, a magnetic storage device, an electronic storage device and an optical storage device. Examples of the magnetic storage device include, but are not limited to, a hard disk drive. Examples of the electronic storage device include, but are not limited to, an electronic memory card storage device. Examples of the optical storage device include, but are not limited to, an optical disk storage device such as a DVD-R or a DVD-RW device.

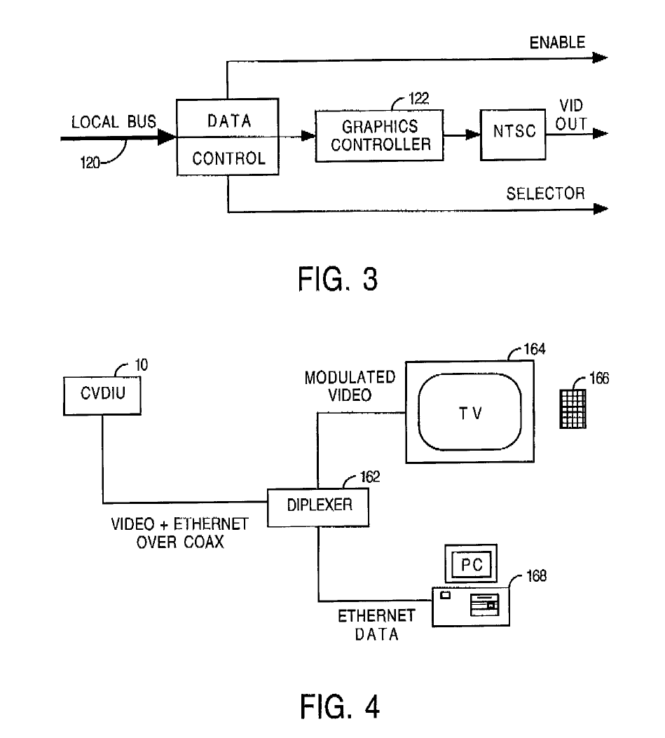

The DPTSCS 44 comprises a data packet to television signal converter 112 and a selector 114. The data packet to television signal converter 112 converts Web-page type information received via the DSL service into a standard television signal, such as NTSC. FIG. 3 is a block diagram of an embodiment of the data packet to television signal converter 112. Data is extracted from a main system bus (LOCAL) 120 and sent to a graphics controller 122. The main system processor 100 sends scaling and position information to the graphics controller 122. The graphics controller 122 generates an interlaced video signal of the Web-page type information based on the scaling and position information. The selector 114 directs the Web-page video to a path associated with its intended destination television set.

Returning to FIG. 2, the MMC 46 in FIG. 1 comprises a plurality of mixer and modulator modules 132, 134, 136 and 140. Each mixer is used to superimpose Web-based television signals from the DPTSCS 44 with video signals from a corresponding one of the video processing modules 82, 84, 86 and 90. Each resulting signal is called a mixed signal. Each modulator is used to modulate a corresponding mixed signal to a specific radio frequency (RF) channel. Each of the modules 132, 134, 136 and 140 generates a modulated signal on its own channel. Each of the television sets 12, 14, 16 and 20 is tuned to receive a corresponding one of the modulated signals. For example, the television sets 12, 14, 16 and 20 may be tuned to receive video on channels 2, 3, 4 and 5, respectively.

The MMC 46 comprises combiners 142, 144, 146 and 150 to combine television signals produced by the modules 132, 134, 136 and 140, respectively, with the data networking signals (e.g. Ethernet signals) produced by the network interface 104. The resulting combined signals are communicated to the television sets 12, 14, 16 and 20, and the PCs 22, 24, 26 and 30 via the in-home coaxial network 61.

In some cases, the in-home coaxial network 61 comprises 75-Ohm coaxial cables, in contrast to so-called “Thin Ethernet” 50-Ohm coaxial cables for which the 10Base2 Ethernet standard was originally created. A 10Base2 signal can be toned or otherwise processed for effective operation over 75-Ohm coaxial cable using widely-available chip sets and discrete parts. The network interface 104 may serve to generate forward data signals suitable for 75-Ohm coaxial cable, and to process return signals from 75-Ohm coaxial cable. Each combined signal may have a lower frequency band for the data networking signal and an upper frequency band for the television signals. For example, the forward and return data networking signals may use a frequency spectrum from DC to approximately 25 MHz or less. This spectrum does not overlap the frequency spectrum required for the television signals.

Using the widely-available technology, the forward and return data signals can be communicated a distance of up to about 500 feet without requiring additional amplification. Combined with video, this baseband signal can be isolated by a diplex filter (such as splitters 72, 74, 76 and 80 shown in FIG. 1) and converted to a more common format such as 10BaseT or Universal Serial Bus (USB).

FIG. 4 is a schematic, block diagram showing an embodiment of a receiving end of the system. The receiving end receives the combined video and data signal via the in-home coaxial network. The combined video and data signal is split using a diplex filter 162. A television 164 is tuned to an appropriate channel at which the video signal is modulated. The television 164 displays video based on the video signal. The video is user-selected by a wireless remote/keyboard 166. A computer 168 has an Ethernet controller responsive to the data signal. The data signal comprises standard Ethernet packets.

Embodiments of the herein-disclosed architecture support many services. Examples of television services which are supported include, but are not limited to, broadcast video services, value-added Web-based services, broadcast video service combined with value-added Web-based services, and video-on-demand. Examples of personal computer services include, but are not limited to, broadband data and home data networking using the in-home coaxial distribution network.

For broadcast video services, after an end-user selects a particular channel using the wireless remote control, the CVDIU's 10 dedicated video processing module for that television set decodes the video and sends a modulated signal to the television set. The television set demodulates the signal and displays the video.

For value-added Web-based services, associated data is converted into an NTSC signal by the DPTSCS 44. The resulting NTSC signal is modulated to a specific channel for the television set. For example, the television sets 12, 14, 16 and 20 may receive video on channels 2, 3, 4 and 5, respectively.

For combined services, the broadcast video is processed in the same manner (e.g. a selected channel is decoded, processed and converted to an NTSC signal). The data for the value-added Web-based service is sent from the NDSPU 42 to the DPTSCS 44. The DPTSCS 44 converts the data into an NTSC signal. The resulting NTSC signal is mixed with the decoded NTSC broadcast video. The data information corresponding to the value-added Web-based services is superimposed on top of the broadcast video. Techniques such as picture-in-picture (PIP) and other mixing alternatives may be deployed to display video and data information on the television set. After mixing the two NTSC signals (converted NTSC data and broadcast video), the mixed signal is modulated using the appropriate modulation channel reserved for the particular television set.

For video-on-demand services, selected VOD content is sent to the MVPU 40 by the NDSPU 42 for decoding. After decoding, the video is modulated for the appropriate television set. VOD can be offered either as a real-time network VOD service or using local storage. Value-added Web-based services can be offered in conjunction with the VOD service following a similar approach described above for combined services.

For the personal computer services, data coming through the DSL network is processed using the Ethernet-over-coax technology of the NDSPU 42, and then sent to a combiner that combines a modulated video signal with the Ethernet data using a different part of the spectrum (e.g. 0-25 MHz). At the receiving end, a diplex filter is used to separate video from the Ethernet data.

Thus, there have been disclosed herein several embodiments including a preferred embodiment of a centralized video and data integration unit.

In summary, embodiments of the CVDIU provide multi-channel video services, integrate broadband data delivery and video delivery to multiple devices from a centralized location inside the home, and eliminate the need for multiple set-top boxes inside the home. An end user only needs to use a remote control to select and view preferred video programming. Video processing modules can be added and removed based on users'subscription preferences and product offerings. The CVDIU may be remotely accessible for management, provisioning, maintenance, troubleshooting and upgrading. Home data networking capabilities are provided using an in-home coaxial distribution network.

Embodiments of the CVDIU have an open architecture to facilitate enhanced services, value-added services, and other services to be offered. Examples of the services include, but are not limited to, Web-based services for a television audience, electronic mail, instant messaging and Web browsing.

It will be apparent to those skilled in the art that the disclosed inventions may be modified in numerous ways and may assume many embodiments other than the preferred forms specifically set out and described herein.

Accordingly, it is intended by the appended claims to cover all modifications which fall within the true spirit and scope of the present invention.

What is claimed is:

1. An apparatus comprising:
a plurality of remote control devices each to receive a user-initiated video selection of any of a plurality of channels;
a plurality of video processing modules, each of the video processing modules responsive to a corresponding one of the remote control devices to request a channel based on the user-initiated video selection;
a distribution module to simultaneously receive all channels requested by the video processing modules and to distribute the channels to those of the video processing modules requesting same;
a plurality of modulators responsive to the video processing modules, each modulator to generate a television signal based on the channel requested an associated one of the video processing modules;
a modem;
a network interface in communication with the modem to provide a data networking signal; and
a plurality of combiners each to combine the television signal from a corresponding one of the modulators with the data networking signal to form a corresponding combined television and data networking signal.

2. The apparatus of claim 1 further comprising a data packet to television signal converter to convert Web-page type information received by the modem to a television signal.

3. The apparatus of claim 2 further comprising a plurality of mixers, each mixer associated with one of the video processing modules to superimpose the television signal from the data packet to television signal converter onto the channel requested thereby.

4. The apparatus of claim 3 further comprising a selector to direct the television signal of Web-page type information to an appropriate one of the mixers.

5. The apparatus of claim 1 wherein the combined television and data networking signal has a lower frequency band for the data networking signal, and an upper frequency band for the television signal.

6. The apparatus of claim 5 wherein the lower frequency band is below 25 MHz.

7. The apparatus of claim 1 wherein the data networking signal is toned for communication over a 75-Ohm coaxial cable.

8. The apparatus of claim 1 further comprising:
at least one card-receiving slot to receive an additional at least one video processing module.

9. The apparatus of claim 1 wherein the modem comprises a digital subscriber line (DSL) modem.

10. The apparatus of claim 1 wherein the remote control devices provide a video recording selection and a video playback selection, wherein the apparatus further comprises a storage device to store video from the video service signal based on the video recording selection and to playback the video based on the video playback selection, wherein each of the video processing modules is responsive to its corresponding one of the remote controls to process the video from the storage device based on the video playback selection and to generate a corresponding television signal based thereon.

11. The apparatus of claim 1 wherein the plurality of channels comprises a plurality of direct broadcast satellite (DBS) channels, and wherein the distribution module comprises a DBS distribution module.

12. An apparatus comprising:
a plurality of remote control devices each to receive a user-initiated video selection of any of a plurality of channels;
a plurality of video processing modules, each of the video processing modules responsive to a corresponding one of the remote control devices to request a channel based on the user-initiated video selection;
a distribution module to simultaneously receive all channels requested by the video processing modules and to distribute the channels to those of the video processing modules requesting same;
a modem;
a network interface in communication with the modem to provide a data networking signal;
a data packet to television signal converter to convert Web-page type information received by the modem to a television signal;
a plurality of mixers, each of the mixers associated with one of the video processing modules;
a selector responsive to the data packet to television signal converter to direct the television signal of Web-page type information to an appropriate one of the mixers;
wherein each of the mixers is to superimpose a television signal directed thereto from the selector onto the channel requested by its associated one of the video processing modules to form a mixed signal;
a plurality of modulators, each of the modulators associated with one of the mixers to modulate its associated mixed signal onto a specific channel; and
a plurality of combiners each to combine the television signal from a corresponding one of the modulators with the data networking signal to form a corresponding combined television and data networking signal.

13. The apparatus of claim 12 wherein the combined television and data networking signal has a lower frequency band for the data networking signal, and an upper frequency band for the television signal.

14. The apparatus of claim 13 wherein the lower frequency band is below 25 MHz.

15. The apparatus of claim 12 wherein the data networking signal is toned for communication over a 75-Ohm coaxial cable.

16. The apparatus of claim 12 further comprising:
at least one card-receiving slot to receive an additional at least one video processing module.

17. The apparatus of claim 12 wherein the modem comprises a digital subscriber line (DSL) modem.

18. The apparatus of claim 12 wherein the remote control devices provide a video recording selection and a video playback selection, wherein the apparatus further comprises a storage device to store video from the video service signal based on the video recording selection and to playback the video based on the video playback selection, wherein each of the video processing modules is responsive to its corresponding one of the remote controls to process the video from the storage device based on the video playback selection and to generate a corresponding television signal based thereon.

19. The apparatus of claim 12 wherein the plurality of channels comprises a plurality of direct broadcast satellite (DBS) channels, and wherein the distribution module comprises a DBS distribution module.
